(19) United States
(12) Patent Application Publication
(10) Pub. No.: US 2019/0139144 A1
(43) Pub. Date: May 9, 2019

(54) SYSTEM, METHOD AND COMPUTER-ACCESSIBLE MEDIUM FOR EFFICIENT SIMULATION OF FINANCIAL STRESS TESTING SCENARIOS WITH SUPPES-BAYES CAUSAL NETWORKS

(71) Applicant: NEW YORK UNIVERSITY, NEW YORK, NY (US)

(72) Inventors: BHUBANESWAR MISHRA, Great Neck, NY (US); DANIELE RAMAZZOTTI, Muggio (MB) (IT); GELIN GAO, JERSEY CITY, NJ (US)

(73) Assignee: NEW YORK UNIVERSITY

(21) Appl. No.: 16/180,502

(22) Filed: Nov. 5, 2018

Related U.S. Application Data
(60) Provisional application No. 62/581,099, filed on Nov. 3, 2017.

(51) Int. Cl. G06Q 40/06; G06N 99/00; G06N 5/04

(52) U.S. Cl. CPC G06Q 40/06; G06N 5/04; G06N 99/005

(57) ABSTRACT

An exemplary system, method and computer-accessible medium for generating a financial stress test(s), can be provided, which can include, for example, receiving financial information, automatically determining a causal network(s) based on the financial information, adjusting a false discovery(ies) in the causal network(s), automatically classifying factor space in the causal network(s) into applicable risky and non-risky constraints, sampling the causal network(s) based on the risky constraints, and electronically generating a financial stress test(s) based on the sampled causal network(s).

### CROSS-REFERENCE TO RELATED APPLICATION(S)

This application relates to and claims priority from U.S. Patent Application Ser. No. 62/581,099, filed on Nov. 3, 2017, the entire disclosure of which is incorporated herein by reference.

### FIELD OF THE DISCLOSURE

The present disclosure relates generally to financial stress testing, and more specifically, to exemplary embodiments of exemplary system, method and computer-accessible medium for efficient simulation of financial stress testing scenarios using Suppes-Bayes causal networks.

### BACKGROUND INFORMATION

Risk management has increasingly become a central part of world finance in the past century. Quantitative risk management generally targets the risk of insolvency; namely, the depletion of capital of a trading agency to the point that the trading agency has to stop its operations. For any trading agency, its account can consist of cash, stocks, bonds or other financial instruments, and net equity, where Equity=Cash+Financial Instruments. The task of quantitative risk management can be to calculate the amount of equity that has to be reserved so that the net equity may not drop to negative. (See, e.g., Reference 8). Depending on different financial agencies, hedge funds, banks or clearing houses, and on different financial instruments, stocks, bonds, or derivatives, the method of risk management can vary, but the central idea behind conventional risk management remains. The statistical distribution of the asset, or portfolio, can be assessed, and the worst-case scenarios can be estimated, generally by exemplary procedures such as a Monte Carlo Simulation. (See, e.g., Reference 17).

However, conventional approaches have been affected by the recent events leading to major financial catastrophes. For example, in the recent 2008 financial crisis, the reserves calculated the risk by using methods such as Value at Risk (“VaR”) (see, e.g., Reference 11) which proved to be wholly inadequate. Due to this, a different method was introduced, (e.g., stress testing). Stress testing refers to the analysis or simulation of the response of financial instruments or institutions, given intensely stressed scenarios that can lead to a financial crisis. (See, e.g., Reference 5). For example, stress testing can model the response of a portfolio when the Dow Jones suddenly drops by, for example, 5%. The difference between stress testing and conventional risk management can be that stress testing deliberately introduces an adversarial, albeit plausible, event, which can thus have a very low probability of occurrence, but still can happen. Thus, stress testing must be capable of observing the response of financial instruments or institutions under extremely rare scenarios that can be unlikely to be observed in conventional risk management, where the simpler system can fail to estimate a 99^{th} percentile of the loss distribution, perhaps leading to a claim that, with 99% confidence level, a specific portfolio can perform well.

Recently, various approaches have been developed to implement some form of stress testing. In terms of stress scenario generation, the most direct method can be the historical one, in which observed events from the past can be used to test contemporary portfolios. (See, e.g., Reference 12). The historical approach can be objective since it can be based on actual events, but it may not be relevant under the present conditions, which can benefit from some hypothetical methods. As an alternative, an event-based method has been proposed in order to quantify a specific hypothetical stress scenario subjectively, by experts or supervisors, and then estimate the possible consequence of such event using macroeconomic and financial models. (See, e.g., Reference 12). Event-based methods rely intensively on expert judgment on whether a hypothetical event can be severely-damaging, albeit still plausible to occur. Sometime such judgment becomes difficult when the relationship between the underlying risk factors and the portfolio can be unknown. To ensure a scenario can be damaging to the portfolio, a portfolio-based method has also been studied in order to link scenarios directly with the portfolio. (See e.g., Reference 12). To this extent, portfolio-based methods can rely on Monte Carlo Simulations to identify the movements of risk factors that stress the given portfolio most severely; however brute force Monte Carlo Simulations can be computationally inefficient, especially when dealing with many risk factors.

Thus, it may be beneficial to provide an exemplary system, method and computer-accessible medium for efficient simulation of financial stress testing scenarios with Suppes-Bayes causal networks, which can overcome at least some of the deficiencies described herein above.

### SUMMARY OF EXEMPLARY EMBODIMENTS

An exemplary system, method and computer-accessible medium for generating a financial stress test(s), can be provided, which can include, for example, receiving financial information, automatically determining a causal network(s) based on the financial information, adjusting a false discovery(ies) in the causal network(s), automatically classifying factor space in the causal network(s) into applicable risky and non-risky constraints, sampling the causal network(s) based on the risky constraints, and electronically generating a financial stress test(s) based on the sampled causal network(s).

In some exemplary embodiments of the present disclosure, the financial information is from a financial institution(s), and the financial information can include factor information and asset information of the financial institution(s). The causal network(s) can be a Suppes-Bayes Causal Network (“SBCN”), and the SBCN can be a directed acyclic graph (“DAG”). The DAG can include a plurality of nodes, where each node of the plurality of nodes can represent a Bernoulli random variable. Each node can have a temporal priority associated therewith. For example, each node of the plurality of nodes can include a conditional probability table. A plurality of branches of the DAG can be generated using the plurality of nodes. Each of the branches can be classified as profitable or lossy. In certain exemplary embodiments of the present disclosure, the risky and non-risky constraints can be classified based on a machine learning procedure(s).

In certain exemplary embodiments of the present disclosure, an optimization procedure can be applied to the causal network(s) to remove unwanted edges and retain only particular edges in the network(s). For example, the particular edges can include genuine causation edges and the unwanted edges can include spurious causation edges. The optimization procedure can be a maximum likelihood optimization procedure. The optimization procedure can be applied using, e.g., a regularization score(s). The financial stress test(s) can be applied to a financial institution(s).

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is an exemplary diagram of the graphical structure of a Bayesian network with four random variables;

FIG. 2 is an exemplary diagram illustrating causal relationships according to an exemplary embodiment of the present disclosure;

FIGS. 3A and 3B are exemplary diagrams illustrating true and spurious causal relationships according to an exemplary embodiment of the present disclosure;

FIG. 4 is an exemplary graph of a performance in an ROC space according to an exemplary embodiment of the present disclosure;

FIG. 5 is an exemplary diagram of the risk classification in the exemplary Suppes-Bayes Causal Networks according to an exemplary embodiment of the present disclosure;

FIG. 6 is an exemplary diagram of a decision tree obtained using the exemplary Suppes-Bayes Causal Networks according to an exemplary embodiment of the present disclosure;

FIG. 7 is an exemplary graph of the distribution of the number of stocks going up according to an exemplary embodiment of the present disclosure;

FIG. 8 is an exemplary flow diagram of an exemplary method for generating stress tests according to an exemplary embodiment of the present disclosure; and

FIG. 9 is an illustration of an exemplary block diagram of an exemplary system in accordance with certain exemplary embodiments of the present disclosure.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and may not be limited by the particular embodiments illustrated in the figures and the appended claims.

### DETAILED DESCRIPTION OF EXEMPLARY EMBODIMENTS

### Exemplary Method

The exemplary system, method and computer-accessible medium, according to an exemplary embodiment of the present disclosure, can use Bayesian Graphical Models (see, e.g., Reference 9), popularly known as Bayesian networks, as a framework to assess stress testing. (See, e.g., Reference 18). Bayesian networks have been used in biological modeling, such as—omics data analysis, cancer progression or genetics (see, e.g., References 2, 10, and 14), but their use in financial stress testing has been limited. Bayesian networks exploit the conditional independence among random variables, whether the variables represent genes or financial instruments. The exemplary system, method and computer-accessible medium, according to an exemplary embodiment of the present disclosure, can utilize a variation of a Bayesian network (See, e.g., References 15 and 16). The exemplary variation of the Bayesian network can be used to constrain the search space of valid solutions, which can be determined using a causal theory based on Suppes' notion of probabilistic causation (see, e.g., References 15, 16 and 23), and which can be exploited in order to generate better learning exemplary procedures. Also, by accounting for Suppes' notion of probabilistic causation, not only can conditional independence be ensured, but also prima facie causal relations among variables can be ensured as well, leading to a more beneficial definition of the actual factors leading to risk. Moreover, through a maximum likelihood optimization procedure, which can make use of a regularization score, it can be possible to only retain edges in the Bayesian network (e.g., graphically depicted as a directed acyclic graph (“DAG”)) that can correspond to only genuine causation, while eliminating all the spurious causes. (See, e.g., References 15 and 16).

Given the inferred network, the network can be sampled to generate plausible scenarios, though not necessarily adversarial or rare. In the case of stress testing, it can be beneficial to also account for rare configurations; because of this, auxiliary tools from various exemplary machine learning procedures can be utilized to discover random configurations that can be both unexpected and undesired.

### Exemplary Bayesian Networks

Bayesian networks can be defined as a DAG G=(V, E), in which each node V can represent a random variable to which a conditional probability table can be associated, and each arc E can model dependency relationships. The nodes can induce an overall joint distribution that can be written as a product of the conditional distributions associated with each variable. (See, e.g., Reference 9). The exemplary system, method and computer-accessible medium, according to an exemplary embodiment of the present disclosure, can analyze Bernoulli random variables with support in (0, 1). Specifically, a dataset D of m observations over n Bernoulli variables can be considered as inputs for the exemplary analyses. (See, e.g., Reference 9).

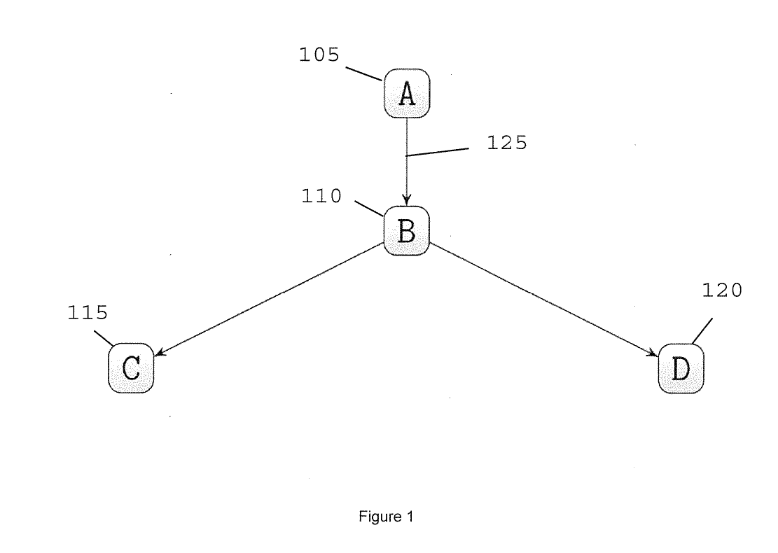

FIG. 1 shows an exemplary diagram of the graphical structure of a Bayesian network. For example as shown in the diagram of FIG. 1, node A (element 105), node B (element 110), node C (element 115), and node D (element 120) can be 4 random variables, and the dependencies among the nodes can be modeled by directed arcs 125. The link A→B can indicate that the knowledge of A (e.g., the parent) can influence the probability of B (e.g., the child), or A and B can be statistically dependent. Furthermore, for node B, node A can be called B's parent, and nodes C and D can be called B's children. In the conditional probability tables related to the described Bayesian network, the rows for node B can specify how the knowledge of A can affect the probability of B being observed. For example, let A and B be both binary random variables with support over (0, 1). Table 1 below specifies the distribution of B under the condition of A, which illustrates the effect of the parent on the child in this example.

TABLE 1
Example of conditional probability table of node B having
node A is unique parent.

| | A = 0 | A = 1 |
|---|---|---|
| B = 0 | P(B = 0\|A = 0) = 0.3 | P(B = 0\|A = 1) = 0.4 |
| B = 1 | P(B = 1\|A = 0) = 0.7 | P(B = 1\|A = 1) = 0.6 |

An exemplary feature of Bayesian networks can be the notion of conditional independence. For any node X in a Bayesian network, given the knowledge of node X's parents, X can be conditionally independent of all nodes that may not be its children, or all its predecessors. (See, e.g., Reference 9). For example, in the Bayesian network shown in the diagram of FIG. 1, node C can be conditionally independent of node A, when conditioned on node B being fixed. Exploiting conditional dependencies when computing the induced distribution of the Bayesian network can be a powerful property since it can simplify the conditional probability table. For example, the conditional probability table of node C may not contain entries P(C|A, B) since P(C|A, B)=P(C|B), or node C can be independent of A conditioned on B: A⊥(C|B).

In the context of stress testing, an exemplary subjective approach to construct Bayesian networks can be used. (See, e.g., Reference 18). After selecting a set of random variables as the nodes of the network, the variables can be subjectively connected, and the relevant conditional probability tables can be assigned with the aid of risk managers or other experts. Then, with the inferred Bayesian network, reasoning about stressed events or simulation can be conducted. (See, e.g., Reference 18).

The exemplary framework can exploit causality to address all the key problems, of which the subjective approach can come short. The subjective approach can be used under the condition of expert knowledge of the causal relationships of some variables. However, such reliance can become unnatural when experts can be confronted with random variables that can be clearly beyond their expertise; for example, the relationship of unemployment and stock market performance or, the relationship of two random stocks. Therefore, instead of completely abandoning the role of data in the construction of a Bayesian network, exemplary procedures can be utilized that can learn both the structure and the conditional probability table of the Bayesian network from the data, which, in turn, can be further augmented by expert knowledge, if deemed necessary.

### Exemplary Suppes-Bayes Causal Networks

The exemplary stress testing procedure can be generated on the foundation of Suppes-Bayes Causal Networks (“SBCNs”), which may not only be more strictly regularized than the general Bayesian networks, but can also include many other attractive features such as interpretability and refutability. SBCNs can exploit the notion of probabilistic causation, originally proposed by Patrick Suppes. (See, e.g., Reference 23).

Suppes described the notion of prima facie causation. (See, e.g., Reference 23). A prima facie relation between any event u and its effect v can be verified when the following two conditions hold: (i) temporal priority (“TP”), for example, any cause happens before its effect and (ii) probability raising (“PR”), for example, the presence of the cause raises the probability of observing its effect.

### Exemplary Definition 1: Probabilistic Causation

(See, e.g., Reference 23). For any two events u and v, occurring respectively at times tᵤ and tᵥ, under the assumptions that O<P(u), P(v)<1, the event u can be called a prima facie cause of v if it occurs before and raises the probability of u, or example,

$$\{ \begin{matrix}( TP ) {t}_{u} < {t}_{v} \\ PR P ( v \vert u ) > P ( v \vert \overline{u} )\end{matrix} \qquad ( 1 )$$

The notion of prima facie causality was exploited for the task of modeling cancer evolution in (see, e.g., References 10, 14, and 4), and the SBCNs have also been described and defined. (See, e.g., References 3, 15 and 16).

### Exemplary Definition 2: Suppes-Bayes Causal Network

An input cross-sectional dataset D of n Bernoulli variables and m samples can be considered, and the SBCN=(V, E) subsumed by D can be a DAG such that the following can hold:

Exemplary Suppes' constraints: for each arc (u→v)∈E involving a prima facie relation between nodes, v∈V, under the mild assumptions that 0<P(u), P(v)<1:

P(u)>P(v) and P(v|u)>P(v|¬u) (2)

Exemplary Simplification: let E′ be the set of arcs satisfying the Suppes' constraints as before; among all the subsets of E′, the set of arcs E can be the one whose corresponding graph can maximize the likelihood of the data and of a certain regularization function R(ƒ):

$$E = {argmax}_{E ⊆ {E}^{′} , G = ( V , E )} ( LL ( D \vert G ) - R ( f ) ) \qquad ( 3 )$$

One of the advantages of SBCNs over general Bayesian networks can be the following. First, with Temporal Priority, SBCN can accommodate the time flow among the nodes. There can be cases where some nodes occur before the other, and it can generally be natural to state that any nodes that happen later cannot be causes, or parents, of nodes that happen earlier. Second, when learning general Bayesian networks, arcs A→B and A←B can sometimes be equally acceptable, resulting in an undirected arc A−B (e.g., this situation can be called a Markov Equivalence). (See, e.g., Reference 9). For SBCNs, such a situation does not arise because of the temporal flow being irreversible. (See, e.g., References 15 and 16). Third, because of the two constraints on the causal links, the SBCN graph can generally be more sparse (e.g., has fewer edges) than the graph of general Bayesian networks with the final goal of disentangling spurious arcs, for example, due to spurious correlations (see, e.g., Reference 13), from genuine causalities.

### Exemplary Machine Learning and Classification

Even if with SBCNs obtain sparser DAGs, Bayesian networks can be used, and the modeled relations can include both positive and negative financial scenarios, but only in the latter case can financial stress arise. Thus, the extreme events, which can be of relevance for stress testing, can still be rare in the data, and unlikely to be simulated in naively generated stress scenarios by sampling from the SBCN directly. Therefore, the exemplary system, method and computer-accessible medium, according to an exemplary embodiment of the present disclosure, can utilize machine learning, for example, feature classification. In stress testing, the unlikely, but risky, scenarios can be targeted. Specifically, when generating random samples from a SBCN to obtain possible scenarios, each node in the SBCN can take any value in its support according to its conditional probability table, generating different branches of scenarios. To narrow down the search space, each possible branch can be classified as leading to profitable or lossy scenarios, and, if the branch can be classified as profitable, then random sampling can be guided to very likely avoid that branch, thus focusing on events and causal relations that can be adversarial and risky, though uncommon. In this way, computation can be reduced significantly to discover the extreme events.

### Exemplary Results and Discussion

### Exemplary Simulating the Training Data

To assess the performance of the exemplary procedure to learn the SBCNs and the quality of inferred Bayesian networks, a set of training data was developed with embedded causal relationships. If the exemplary procedures, when performed on the training data can be capable of accurately recovering the causal relationships embedded in them, then such accuracy can be expected on real data.

To simulate the training data, a common stock factor model, the Fama French Five Factor Model (see, e.g., Reference 7), was utilized where the return of the asset can be defined as follow:

r=R_{ƒ}+β₁(Kₘ−R_{ƒ})+β₂SMB+β₃HML+β₄RMW+β₃CMA+∝ (4)

In Eq. (4), r can be the return of the asset, R_{ƒ} can be the risk free return, usually measured in terms of government treasury returns, (i) Kₘ can be or include a market factor, measured as value-weighted market portfolio, similar to stock indexes, (ii) Small Minus Big (“SMB”) can be or include a company size factor, measured by return on a diversified portfolio of small stocks minus the return on a diversified portfolio of big stocks, (iii) HighMinus Low (“HML) can be or include a company book-to-market (“B/M”) ratio factor, measured by difference between the returns on diversified portfolios of high and low B/M stocks, where B/M can be the ratio between company's book value to market value, (iv) Robust Minus Weak (“RMW”) can be or include a company operating profitability factor, measured by the returns on diversified portfolios of stocks with robust and weak profitability and (v) Conservative Minus Aggressive (“CMA”) can be or include a company investment factor, where the difference between the returns on diversified portfolios of low and high investment stocks, called conservative and aggressive. (See, e.g., Reference 7).

To simulate the training data with embedded causal relationship, the historical returns r were linearly regressed onto the five factors, and the distribution of each factor coefficient and the empirical residual were obtained. A characterization of a SBCN can be an underlying temporal model of the causal relations depicted in the network, (e.g., the temporal priority between any pair of nodes which can be involved in a causal relationship). Therefore, the five factors described in the exemplary generative model were lagged with respect to the historical returns to comply with the temporal priority. Thus, for example:

r_{i,t}=Σ_{i,j}β_{i,j}ƒ_{j,t-lag+∈} (5)

Then, the simple training data was simulated by randomly drawing the factor coefficients β_{i,j} and residuals ∈ from the distribution obtained from the linear regression, and these coefficients and residuals were applied on a set of new factor data. Such historical data can consist of a daily series of five factors and returns of 10 portfolios also constructed by Fama French, and of 10,000 days. The first 5,000 for regression and the other 5,000 for simulation were used.

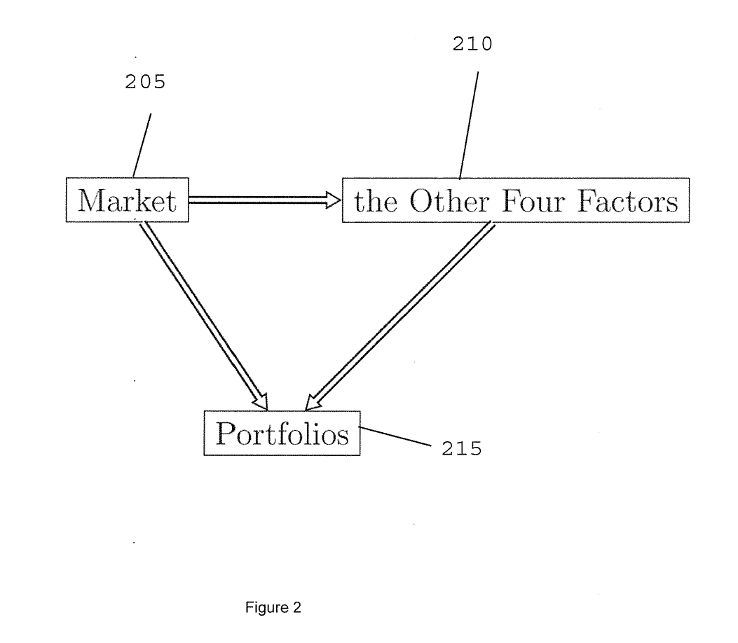

Many factors can present causal relationships among themselves. For example, some factors may not directly influence the asset, but can affect the asset indirectly by affecting other factors. Therefore, the simulated training data can be complicated by embedding spurious relationships also among factors. Some factors can be linearly regressed on to the other factors, and the training data was simulated in a similar manner. The choice of factors can be arbitrary. The exemplary system, method and computer-accessible medium, according to an exemplary embodiment of the present disclosure, can be used to regress the other four factors SML, HML, RMW and CMA on the market factor Kₘ. The causal relationships which are described in the simulated training data can be simplified as shown in the diagram of FIG. 2, which illustrates the relationship between Market 205, the four other factors 210, and portfolios 215.

### Exemplary Learning the SBCNs

The exemplary results below show simulations generated on networks of 15 nodes, for example, 10 stocks and 5 factors with the generative model discussed above. Each node can represent a Bernoulli random variable taking binary values in (0, 1), where 1 can represent the stock or factor going up, and 0 can represent the stock or factor going down. Specifically, the input of the exemplary learning task can be a dataset D of n×m binary entries. There may be no explicit observation of time in the data (see, e.g., Reference 3), which can instead be cross-sectional and, because of this, a topological ranking r can be provided as a further input to the exemplary procedure providing information about the temporal priority among the nodes. In the case of these experiments, ranking a time precedence of the factors before the stocks can be set, for example, in the exemplary model factors, and can affect stocks but not the other way around.

Exemplary Procedure 1 below illustrates the learning procedure adopted for the inference. Given the above mentioned inputs, Suppes' constraints can be verified (e.g., Lines 3-8) to first construct a DAG. Then, the likelihood fit can be performed by hill climbing (e.g., Lines 9-20), an iterative optimization procedure that can start with an arbitrary solution to a problem (e.g., in the exemplary case an empty graph) and then can attempt to find a better solution by incrementally visiting the neighborhood of the current one. If the new candidate solution can be better than the previous one, it can be considered in place of it. The exemplary procedure can be repeated until the stopping criterion can be matched. In the exemplary implementation, the ! StoppingCriterion can occur (e.g., Line 11) in two situations: (i) the exemplary procedure can stop when a large enough number of iterations has been performed or, (ii) it can stop when none of the solutions in G_{neighbors} can be better than the current G_{fit}, where G_{neighbors} can denote all the solutions that can be derivable from G_{fit} by removing or adding at most one edge.

### Exemplary Problem of False Discovery

Exemplary Procedure 1 Learning the SBCN

```
  1: Inputs: D an input dataset of n Bernoulli variables and
    m samples, and r a partial order of the variables
  2: Output: SBCN(V, E) as in Definition 2
  3: [Suppes' constraints]
  4: for all pairs (v, u) among the n Bernoulli variables do
  5:  if r(v) ≤ r(u) and P(u | v) > P(u | ¬v) then
  6:  add the are (v, u) to SBCN.
  7:  end if
  8: end for
  9: [Likelihood fit by hill climbing]
10: Consider G(V, E)_{fit} = ∅.
11: while !StoppingCriterion( ) do
12:  Let G(V, E)_{neighbors} be the neighbor solutions of
      G(V, E)_{fit}.
13:  Remove from G(V, E)_{neighbors} any solution whose
      arcs are not included in SBCN.
14:  Consider  a  random  solution  G_{current}  in
      G(V, E)_{neighbors}.
15:  if  score_{REG}(D, G_{current})  >  score_{REG}(D, G_{fit})
      then
16:  G_{fit} = G_{current}.
17:  end if
18: end while
19: SBCN = G_{fit}.
20: return SBCN.
```

The performance of exemplary Procedure 1 was tested on a training data of 10 portfolios, 5 factors and 2,500 observations. On such settings, the exemplary procedure recovered almost the whole set of embedded causal relationships with only 6 false negatives, roughly, 15% of total arcs; however, the number of false positives were larger, reaching around 35% of the total causal arcs obtained, thus needing more attention to how the model was regularized.

The explanation for this kind of trend can be found in how the exemplary procedure can implement the regularization via Bayesian Information Criterion (“BIC”) (see, e.g., Reference 21), that can be, for example:

BIC=k·ln(N)−2 ln(L), (6)

where k can be the number of arcs in the SBCN (e.g., number of causal relationships), n can be the number of observations of the data, and L can be the likelihood. The exemplary procedure can search for the Bayesian network that can minimize the BIC.

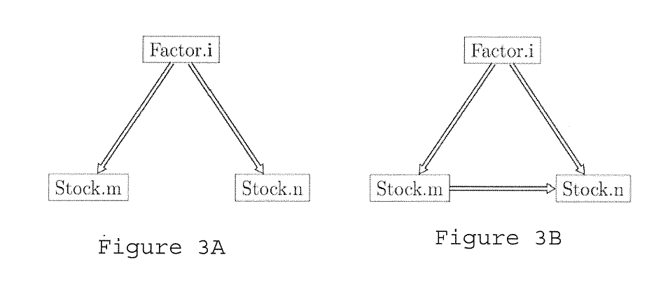

For a large number of observations, the maximum likelihood optimization can ensure that asymptotically, all the embedded relationships can be explored, and the most likely solution can be recovered. However, the maximum likelihood is known to be susceptible to overfitting (see, e.g., Reference 9), especially when, as in the exemplary case, it deals with small sample size in the training data. Furthermore, in the training data, all the portfolios can be assumed to depend on the same five factors, although with different coefficients, although very likely some portfolios can have very similar coefficients, resulting in co-movements across the portfolios. This co-movement can induce correlations that can affect the probability raising, and thus the spurious prima facie causal relations, making these settings an interesting, yet, very hard test case. For example, the diagram shown in FIG. 3A illustrates the true causal relationships that emerged from simulated data, while the diagram shown in FIG. 3B illustrates spurious relationships that emerged from simulated data.

### Exemplary Sample Size and Information Criterion

To reduce the spurious causalities, some exemplary intrinsic properties of the information criteria can be utilized. The BIC=k·ln(N)−2 ln(L), not only can maximize the likelihood, but can also penalize the complexity of the model by the term k·ln(N). For small sample sizes, BIC can generally be biased towards simple models because of the penalty. However, for large sample size, BIC can accept complex models. (See, e.g., Reference 9).

In the exemplary simulations, a sample size of 2,500 was used, which is considerably large for the score. Therefore using BIC can lead to the inference of a relatively complex model with a number of unnecessary spurious arcs. Using smaller sized data, and letting the complexity penalty take a bigger effect in BIC score, can reduce this problem. This can also address the non-stationarity in the data; an endemic problem for financial data. Following this intuition, further experiments were performed by reducing the original sample size of 2,500 samples, which describes around 10 years of data, in turn to 252 and 500, and a significant reduction in the number of false positives, to 13% and 19% of total arcs, respectively, was observed. However, at the same time, because of smaller sample size, the number of false negatives increased to around 35% of total arcs.

To reconcile this dilemma, a new information criterion, Akaike Information Criterion (“AIC”) (see, e.g., Reference 1), can be considered, which can be defined, for example, as:

AIC=2k−ln(L) (7)

For AIC, the coefficient of k can be set to 2, leading to a definitively smaller factor than ln(N) of BIC when the sample size N can be large. For this reason, AIC can accept more complex models for given sample sizes than BIC. Applying AIC on small size data, the number of false negatives can decrease to 10% of the total arcs, while the number of false positive can still be large, remaining around the 34%.

### Exemplary Model Selection by Bootstrapping

Different characteristics of two state-of-the-art likelihood scores with respect to the number of obtained false positive and false negative arcs can be seen. Specifically, a trade-off where, because of their characteristics, the best results on large sample sizes can be obtained using BIC, while for small sample sizes AIC can be more effective, but neither of the two regularization procedures has a satisfactory trend. To improve their performance, a bootstrap procedure for model selection can be used. (See, e.g., Reference 6)

The idea of bootstrap can be as follows: the structure and parameters of the SBCN can be learned, but a resampling procedure can subsequently be performed where repetitions data from the dataset can be sampled in order to generate a set of bootstrapped datasets, for example, 100 times, and then the relative confidence level of each arc in the originally inferred SBCN can be calculated, by performing the inference from each of the bootstrapped dataset and counting how many times a given arc can be retrieved. Thus, a confidence level for any arc in the SBCN can be obtained.

The exemplary approach described above can be tested on the exemplary simulations, and the confidence level of spurious arcs can typically be smaller than the confidence level for true causal relations, which can be empirically observed. Therefore, a procedure for pruning the inferred SBCN to constrain for a given minimum confidence level can be applied. Such a threshold can reflect the number of false positive that can be included in the exemplary model, with higher thresholds ensuring sparser models. Here, an exemplary approach can be tested by utilizing a minimum confidence level of 0:5, for example, any valid arc should be retrieved at least half of the times.

Table 2 below illustrates the contingency table resulting from the exemplary experiments.

TABLE 2
Contingency Table of the Performances of Different Information
Criteria and Sample Sizes.

| | BIC | | BIC Boot | | AIC | | AIC Boot | |
|---|---|---|---|---|---|---|---|---|
| Sample | FP | FN | FP | FN | FP | FN | FP | FN |
| 252 | 13.7 | 34.5 | 10.7 | 50 | 34.2 | 10.5 | 19.4 | 16.1 |
| 500 | 19.3 | 25.8 | 16.7 | 36.7 | 35.8 | 7.7 | 24.2 | 16.1 |
| 1000 | 26.5 | 20.6 | 19.4 | 25.8 | 37.5 | 0.0 | 26.5 | 5.9 |
| 2500 | 34.2 | 15.8 | 26.5 | 17.6 | 41.9 | 0.0 | 32.4 | 0.0 |
| 3500 | 34.2 | 7.9 | 26.5 | 8.8 | 43.2 | 0.0 | 34.2 | 0.0 |
| 5000 | 38.2 | 0.0 | 26.5 | 0.0 | 45.7 | 0.0 | 35.9 | 0.0 |

Table 2 above presents the results in terms of false positives (“FP”) and false negatives (“FN”) of the various methods on the training data with different information criteria, sample sizes, and whether Bootstrapping can be applied. The trade-off between false positive rates and false negative rates usually can be case-specific. In general, the objective of such an approach can be to correctly and precisely recover the true distribution underlying the training data. For this reason, unless differently specified for specific uses, there may not be an overall preference toward either lower false positive or lower false negative. Therefore, the exemplary methods can be evaluated by considering the sum of both false positive and false negative rates. This metric can be biased toward a combination of relatively low FP and FN rather that the combination of very low FP and high FN and so on. By analyzing the results shown in Table 2, a trend can be Observed where AIC with Bootstrapping on small sample datasets (e.g., 252) and BIC with Bootstrapping on large sample datasets (e.g., 5,000) can produce the best results, which is consistent with the discussion above. Also, it can be observed that both for AIC without any bootstrapping on sample sizes of 252, and BIC without any bootstrapping on sample size of 5,000, the false positive rates can be reduced by around 30%, without significant increase in the false negative rates.

### Exemplary Assumption of Sparse Relationships

The resulting false positive rate of around 20% can still seem relatively high. But, one important assumption can be beneficial. In the training data, such a high false positive rate can derive from the fact that portfolios can be dependent on the 5 common factors, which can induce co-movements. However, in the real data, such nested dependencies do not always occur, while a feature of sparse relationships can appear frequently, and portfolios can depend on distinctively small sets of factors. This assumption of sparsity can significantly improve the performance of the exemplary procedure. Implementing this sparsity on a new set of purely random training data, and following the BIC with Bootstrapping method mentioned above, a sample size (e.g., 252 samples) can produce 10% false positive and 5% false negative rates, while a large sample size (e.g., 2,500 samples), can produce 10% false positive and 0% false negative rates.

### Exemplary Summary of ROC Space

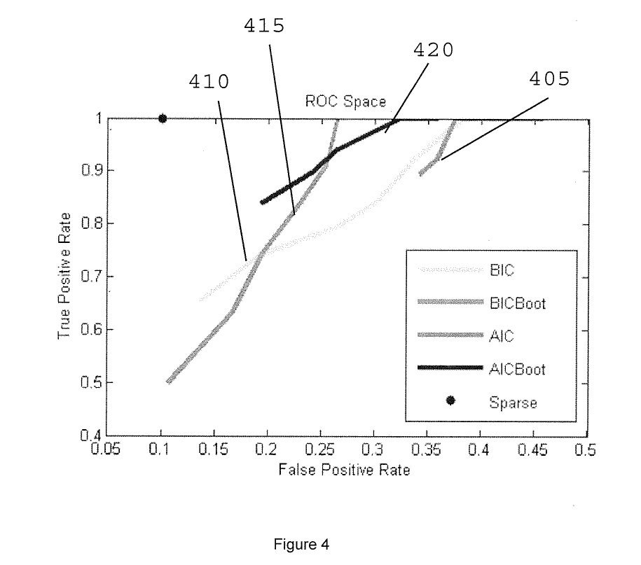

FIG. 4 shows an exemplary graph that illustrates interpolation and smoothing out of kinks in the ROC space whose x axis can represent the False Positive Rate and y axis can represent the True Positive Rate. ROC Space can illustrate the performance of the different methods described herein on different sample sizes. By looking at the plot, one can observe that AICs 405 generally have high true positive rates but also high false positive rates, as a result of its less stringent complexity penalty. On the other side, BICs 410 generally have smaller false positive rates, but its true positive rates can also be lower. Comparing the procedures with and without bootstrapping, the bootstrap procedure shifts the curves to the left (e.g., BICboot 415 and AICBoot 420). Still, the best performance lies in the data with the assumption of sparse relationships. Based on these results, with Bootstrapping and the assumption of sparse relationships, the exemplary procedure can accurately recover the causal relationships in the data.

### Exemplary Stress Testing

### Exemplary Risk Management by Simulations

After the inference of the SBCN, a Monte Carlo Simulation can be performed in the same manner as for conventional risk management, by drawing on a large number of samples to discover the worst 5% scenarios as the VaR. However, in stress testing, the most extreme events, which have very low but non-zero probability of occurrence and thus they still can occur, can be targeted (e.g., the 2008 financial crisis or the most recent market reactions to “BREXIT”). Therefore, when drawing samples from the network, the normal scenarios can be rejected, and more importance can be placed on the extreme events. To achieve this goal, when conducting random sampling, each possible branch can be classified as either profitable or risky, and if the branch can be classified as profitable, then that branch can be avoided.

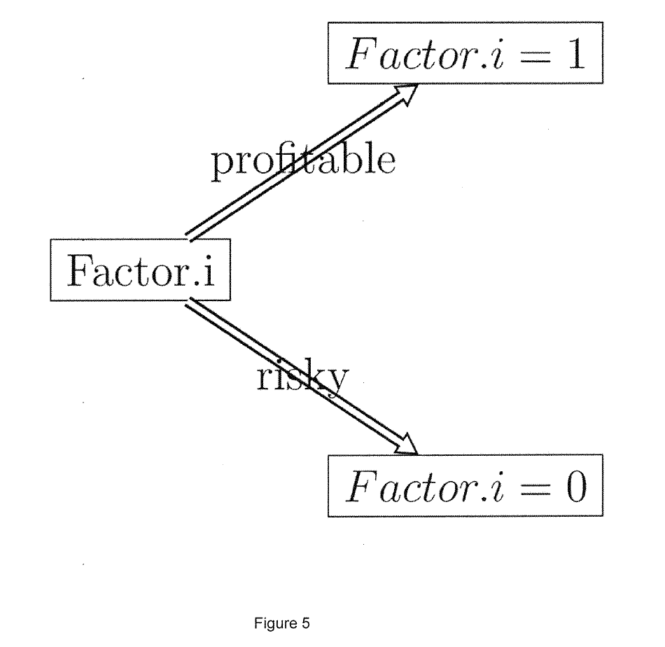

FIG. 5 shows a diagram that illustrates a simple binary classification where, for this factor, only factor i with value 0 can be considered risky and, thus, this scenario can be the only one to be sampled. Thus, the extremely risky events and reduced computation can be targeted. However, unlike conventional risk management, this exemplary approach may not facilitate the estimation of the probability of occurrence of the sampled extreme events. Therefore, a value at risk may not be concluded with a certain confidence level.

The simple binary classification with certain features can be a machine learning problem. The exemplary system, method and computer-accessible medium, according to an exemplary embodiment of the present disclosure, can utilize a solution of such a task based on decision trees. (See, e.g., Reference 20). A decision tree can be a predictive model that maps features of an object to a target value of the object. The features can be the factors of interest, and the target value can be whether the portfolio can be profitable or lossy. To perform a classification, 1,000 samples from the inferred SBCN were drawn. Then, a simple portfolio was constructed, which was long on all the stocks in the SBCN by the same amount, and the Profit and Loss (“P/L”) of each observation was calculated. Here however, because the underlying SBCN can depict binary variables, exact P/L statistics were not obtained. Instead, since the toy portfolio was long on all stocks by the same amount, the ratio of stocks that goes up is an approximate measure of risk. For continuous Bayesian network, Profit and Loss was calculated directly. Then, this measure was sorted, and the least 100 were denoted as risky, and the rest as profitable. The 100 ‘risky’ scenarios included at least 7 stocks that fall. Then 1,000 samples were considered; each of them labeled as ‘risky’ or ‘profitable’. In the exemplary experiments, the R ‘tree’ package was utilized. (See, e.g., Reference 19).

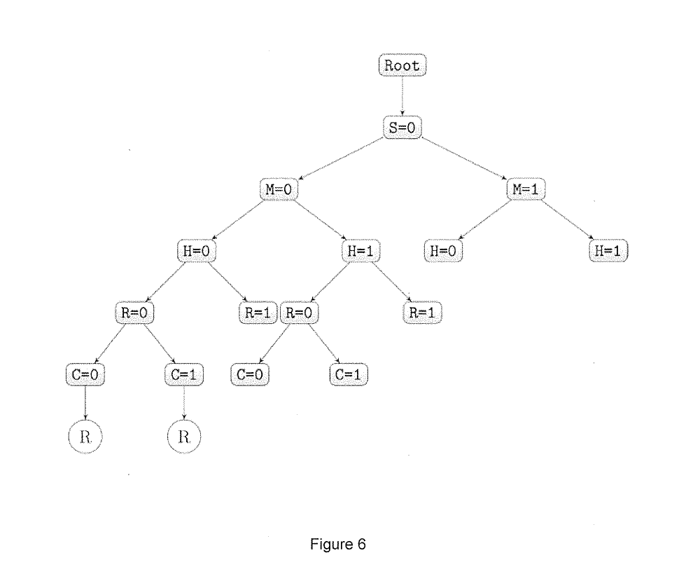

Using the SBCN learned from the simulated training data, the following decision tree shown in the diagram of FIG. 6 can be obtained. For example, in the decision tree shown in the diagram of FIG. 6, S can denote factor SMB; Mean denote Market Kₘ; II can denote HML; R can denote RMW and C can denote CMA. Here, only the left part of the entire obtained decision tree is shown; the subtree with S=1 can be omitted, since the entire subtree with S=1 can be classified as ‘Profitable’, which may not be of interest for stress testing. In the exemplary tree, two paths that can be classified as ‘Risky’: Path S=0, M=0, H=0, R=0, C=0 and Path S=0, M=0, H=0, R=0, C=1 can be identified. The paths classified can be intuitive, since the exemplary portfolio can be long with equal amount invested over all 10 stocks. Since 10 stocks can generally be positively dependent on the factors, most factors with 0 values can likely induce a ‘Risky’ path. For more complicated portfolios and real factors, such intuition cannot be easily found. Thus, the result of the classification may have to be relied on.

### Exemplary Scenario Generation and Results

In view of the exemplary tree shown in the diagram of FIG. 6, the bn learn R package (see, e.g., Reference 22) was used to sample from the SBCN. Given the network, random scenarios can be simulated, however, not all of them can be simulated, which can prove to be inefficient, but following the information provided by the classification tree, the configurations which can be likely to indicate risk to drive the exemplary sampling can be chosen. For instance, to do so, the first path in the exemplary tree can be picked, which can be S=0, M=0, H=0, R=0, C=0, and can constrain the distribution induced by the SBCN. In order to avoid sampling the scenarios which may not be in accordance with the path, the conditional probability table of the SBCN can be adjusted. Since paths with all five factors taking value 0 can be beneficial, the conditional probability of these five factors taking value 1 to 0 can be set, and the conditional probability of factors taking value 0 to 1. Thus, the undesirable paths can be unlikely to be simulated, while the intrinsic distribution of how factors affect the stocks can still be modeled. More sophisticated exemplary implementations based on this intuition can be possible; for example, using branch-and-bound, policy valuation, tree-search, etc.

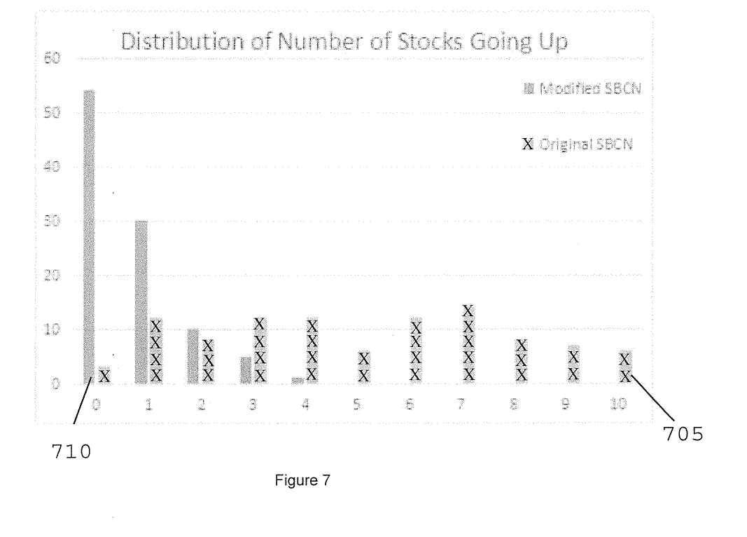

FIG. 7 shows a diagram comparing the exemplary results of the simulations given the original SBCN 705, and one taking into account (i) the decision tree, (ii) the distribution of the risk measure, and (iii) the number of stocks that go up.

For example, a number of stocks going up from 100 samples generated by the original SBCN 705 can be roughly evenly distributed. At the same time, the 100 samples generated by the modified SBCN 710 can contain no scenarios with more than 5 stocks going up, and 84 out of the 100 samples have at most 1 stock going up. The modified SBCN places can have far more importance on the stressed scenarios, and in turn can confirm the result of the classification procedure by the decision tree. Thus, computation of generating stressed scenarios can be saved tremendously. This kind of computational efficiency issues can be more beneficial when simple Bernoulli random variable can be moved to multi-categorical variables or continuous random variable. Therefore, with the same computing power, the modified SBCN 710 can make it possible to generate more stressed scenarios, and observe how portfolios or other assets respond to stressed factors.

### Exemplary Conclusions

The exemplary system, method and computer-accessible medium, according to an exemplary embodiment of the present disclosure, can be used to perform stress testing combining Suppes-Bayes Causal Networks and machine learning classifications. SBCNs can be learned from data using exemplary Procedure 1 shown above, and can assess the quality of the learned model by switching information criteria based upon sample sizes and bootstrapping. Stress scenarios can be simulated using SBCNs, but computation can be reduced by classifying each branch of nodes in the network as “profitable” or “risky” using classification trees. The exemplary SBCNs can be implemented with Bernoulli variables, and can simulate data using Fama French's Five Factor Model, but the logic of the problem can be easily extended to more practical situations. For example, the SBCNs can accommodate more complicated variables (e.g., nodes). In additional to the factor based portfolios, other factor models, or directly other financial and economic factors like foreign exchange rates, can also be included, and the accuracy of the exemplary model can ensure that the true causal relationships among the factors can be discovered. In practice, variables like stock prices can be continuous, thus, one can easily extend to these situations by adopting a hybrid SBCN, where the variables can take either discrete or continuous values, making it possible to represent precisely the values of the variables of interest.

To use the exemplary model, the role of experts can be still beneficial. After learning the SBCN from data, and applying a classification, a number of stressed scenarios can be identified. However, some of them can be expected to be unreasonable and implausible to occur. These scenarios can be highly stressed with respect to the corresponding portfolio but they could prove to be less useful in practice. Therefore, experts can select only plausible one from the identified stressed scenarios, and discard the impossible ones. Even in this case, simulations can be performed following the selected stressed paths in the SBCN and the reactions of the portfolios in these stressed scenarios of interest can be observed, and the portfolios can be adjusted based on the reactions. Another direct usage of the exemplary approach can be when experts have a particular stressed scenario as interested a priori; in this case one can skip the process of classification and can directly adjust the SBCN in the same way. Therefore, simulations of the adjusted SBCN can also offer the reactions of the portfolio to this particular stressed scenario.

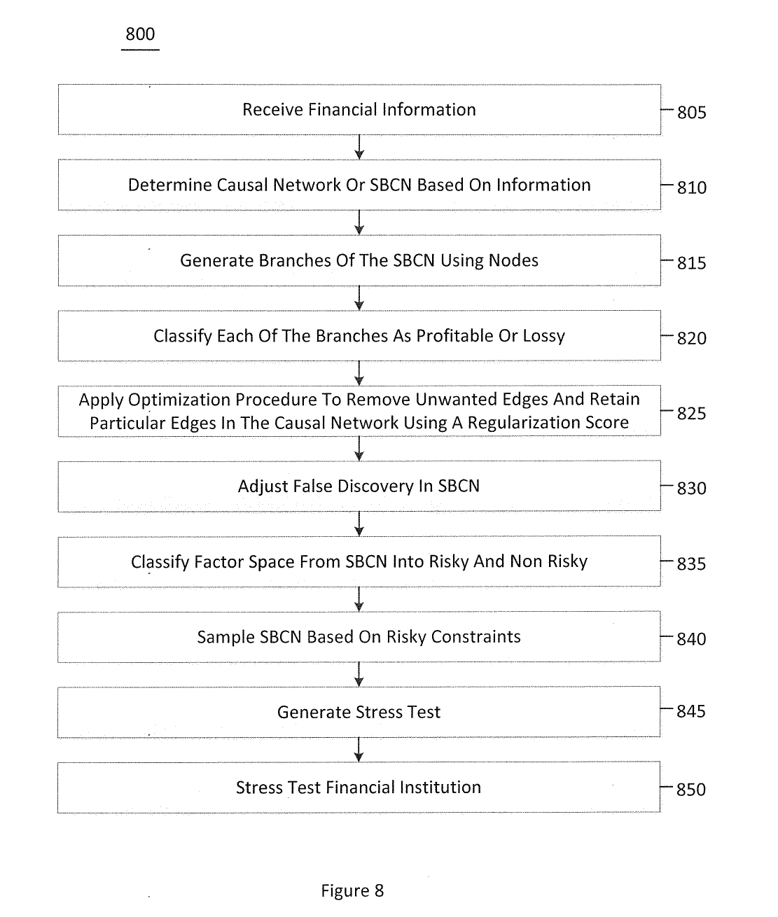

FIG. 8 shows an exemplary flow diagram of an exemplary method 800 for generating stress tests according to an exemplary embodiment of the present disclosure. For example, at procedure 805, financial information (e.g., from a financial institution) can be received. At procedure 810, a causal network or a SBCN can be determined based on the financial information. At procedure 815, branches of the SBCN, which may be a DAG, can be generated. At procedure 820, each of the branches can be classified as profitable or lossy. At procedure 825, an optimization or can be applied to the causal network, or SBCN, to remove unwanted edges and retain only particular edges in the causal network (e.g., using a regularization score). False discoveries in the SBCN can be adjusted at procedure 830, and the factor space from the SBCN can be classified at procedure 835. At procedure 840, the SBCN can be sampled based on risky constraints, and one or more stress tests can be generate at procedure 845 based on the sampled SBCN. Such one or more stress tests can be used to stress test a financial institution at procedure 850.

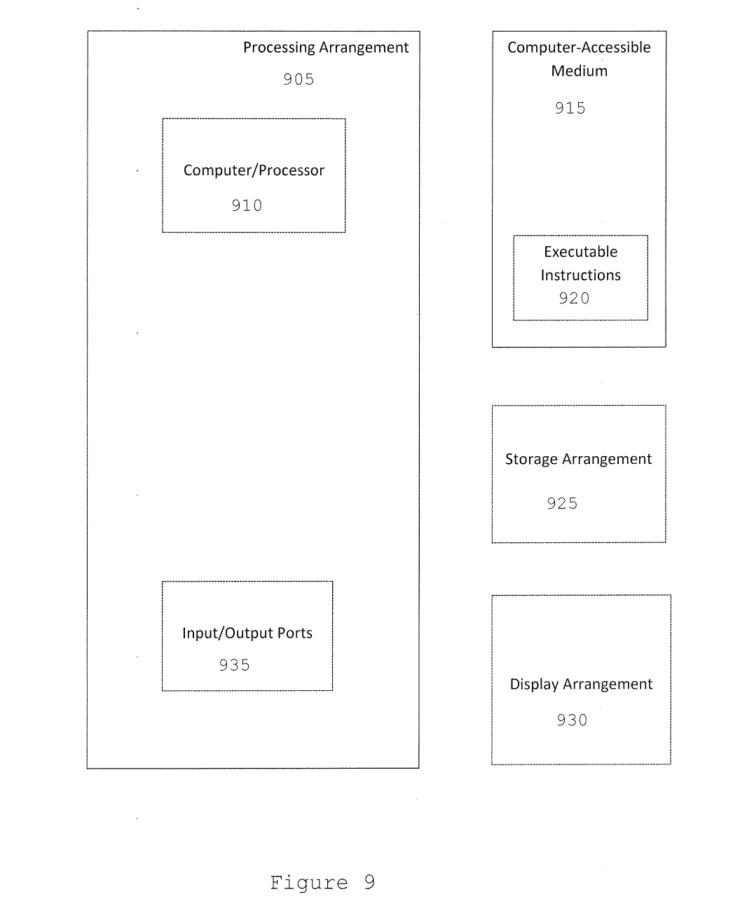

FIG. 9 shows a block diagram of an exemplary embodiment of a system according to the present disclosure. For example, exemplary procedures in accordance with the present disclosure described herein can be performed by a processing arrangement and/or a computing arrangement 905. Such processing/computing arrangement 905 can be, for example entirely or a part of, or include, but not limited to, a computer/processor 910 that can include, for example one or more microprocessors, and use instructions stored on a computer-accessible medium (e.g., RAM, ROM, hard drive, or other storage device).

As shown in FIG. 9, for example a computer-accessible medium 915 (e.g., as described herein above, a storage device such as a hard disk, floppy disk, memory stick, CD-ROM, RAM, ROM, etc., or a collection thereof) can be provided (e.g., in communication with the processing arrangement 905). The computer-accessible medium 915 can contain executable instructions 920 thereon. In addition or alternatively, a storage arrangement 925 can be provided separately from the computer-accessible medium 915, which can provide the instructions to the processing arrangement 905 so as to configure the processing arrangement to execute certain exemplary procedures, processes and methods, as described herein above, for example.

Further, the exemplary processing arrangement 905 can be provided with or include an input/output arrangement 935, which can include, for example a wired network, a wireless network, the internet, an intranet, a data collection probe, a sensor, etc. As shown in FIG. 9, the exemplary processing arrangement 905 can be in communication with an exemplary display arrangement 930, which, according to certain exemplary embodiments of the present disclosure, can be a touch-screen configured for inputting information to the processing arrangement in addition to outputting information from the processing arrangement, for example. Further, the exemplary display 930 and/or a storage arrangement 925 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### EXEMPLARY REFERENCES

The following references are hereby incorporated by reference in their entireties.
[1] H. Akaike. Information theory and an extension of the maximum likelihood principle. In Selected Papers of Hirotugu Akaike, pages 199-213. Springer, 1998.
[2] N. Beerenwinkel, N. Eriksson, and B. Sturmfels. Conjunctive bayesian networks. Bernoulli, pages 893-909, 2007.
[3] F. Bonchi, S. Hajian, B. Mishra, and D. Ramazzotti. Exposing the probabilistic causal structure of discrimination. arXiv preprint arXiv:1510.00552, 2015.
[4] G. Caravagna, A. Graudenzi, D. Ramazzotti, R. Sanz-Pamplona, L. De Sano, G. Mauri, V. Moreno, M. Antoniotti, and B. Mishra. Algorithmic methods to infer the evolutionary trajectories in cancer progression. PNAS, 2016.
[5] S. Claessens and M. A. Kose. Financial crises: Explanations, types and implications. IMF Working Paper Series, 2013.
[6] B. Efron. Nonparametric estimates of standard error: the jackknife, the bootstrap and other methods. Biometrika, 68(3):589-599, 1981.
[7] E. F. Fama and K. R. French. Multifactor explanations of asset pricing anomalies. The journal of finance, 51(1):55-84, 1996.
[8] A. J. McNeil, R. Frey, and P. Embrechts. Quantitative Risk Management: Concepts, Techniques and Tools. Princeton University Press, 2010.
[9] D. Koller and N. Friedman. Probabilistic graphical models: principles and techniques. MIT press, 2009.
[10] L. O. Loohuis, G. Caravagna, A. Graudenzi, D. Ramazzotti, G. Mauri, M. Antoniotti, and B. Mishra. Inferring tree causal models of cancer progression with probability raising. PloS one, 9(10):e108358, 2014.
[11] S. Manganell and R. F. Engle. Value at risk models in finance. European Central Bank Working Paper Series, 2001.
[12] C. on the Global Financial System. Stress testing at major financial institutions: survey results and practice. 2005.
[13] K. Pearson. Mathematical contributions to the theory of evolution-on a form of spurious correlation which may arise when indices are used in the measurement of organs. Proceedings of the royal society of london, 60(359-367):489-498, 1896.
[14] D. Ramazzotti, G. Caravagna, L. O. Loohuis, A. Graudenzi, I. Korsunsky, G. Mauri, M. Antoniotti, and B. Mishra. Capri: efficient inference of cancer progression models from cross-sectional data. Bioinformatics, 31(18):3016-3026, 2015.
[15] D. Ramazzotti, A. Graudenzi, G. Caravagna, and M. Antoniotti. Modeling cumulative biological phenomena with suppes-bayes causal networks. arXiv preprint arXiv:1602.07857, 2016.
[16] D. Ramazzotti, M. Nobile S, A. Graudenzi, and M. Antoniotti. Learning the probabilistic structure of cumulative phenomena with suppes-bayes causal networks. Submitted, 2016.
[17] S. Raychaudhuri, S. J. Mason, R. R. Hill, L. MÃünch, O. Rose, T. Jefferson, and J. W. Fowler. Introduction to monte carlo simulation. In 2008 Winter Simulation Conference, 2008.
[18] R. Rebonato. Coherent Stress Testing: a Bayesian approach to the analysis of financial stress. John Wiley & Sons, 2010.
[19] B. Ripley. Tree: Classification and Regression Trees, 2016. R package version 1.0-37.
[20] S. R. Safavian and D. Landgrebe. A survey of decision tree classifier methodology. 1990.
[21] G. Schwarz et al. Estimating the dimension of a model. The annals of statistics, 6(2):461-464, 1978.
[22] M. Scutari. Learning bayesian networks with the bn learn r package. arXiv preprint arXiv:0908.3817, 2009.
[23] P. Suppes. A probabilistic theory of causality. North-Holland Publishing Company Amsterdam, 1970.

What is claimed is:

1. A non-transitory computer-accessible medium having stored thereon computer-executable instructions for generating at least one financial stress test, wherein, when a computer arrangement executes the instructions, the computer arrangement is configured to perform procedures comprising:
receiving financial information;
automatically determining at least one causal network based on the financial information;
adjusting at least one false discovery in the at least one causal network;
automatically classifying factor space in the at least one causal network into risky and non-risky constraints;
sampling the at least one causal network based on the risky constraints; and
electronically generating at least one financial stress test based on the sampled at least one causal network.

2. The computer-accessible medium of claim 1, wherein the financial information is from at least one financial institution.

3. The computer-accessible medium of claim 2, wherein the financial information includes factor information and asset information of the at least one financial institution.

4. The computer-accessible medium of claim 1, wherein the at least one causal network is a Suppes-Bayes Causal Network (SBCN).

5. The computer-accessible medium of claim 4, wherein the SBCN includes a directed acyclic graph (DAG).

6. The computer-accessible medium of claim 5, wherein the DAG includes a plurality of nodes.

7. The computer-accessible medium of claim 6, wherein each node of the plurality of nodes represents a Bernoulli random variable.

8. The computer-accessible medium of claim 6, wherein each node has a temporal priority associated therewith.

9. The computer-accessible medium of claim 6, wherein each node of the plurality of nodes includes a conditional probability table.

10. The computer-accessible medium of claim 9, wherein the computer arrangement is further configured to generate a plurality of branches of the DAG using at least one of the plurality of nodes.

11. The computer-accessible medium of claim 10, wherein the computer arrangement is further configured to classify each of the branches as profitable or lossy.

12. The computer-accessible medium of claim 1, wherein the computer arrangement is configured to classify the risky and non-risky constraints based on at least one machine learning procedure.

13. The computer-accessible medium of claim 1, wherein the computer arrangement is further configured to apply an optimization procedure to the at least one causal network to remove unwanted edges and retain only particular edges in the at least one causal network.

14. The computer-accessible medium of claim 13, wherein the particular edges include genuine causation edges.

15. The computer-accessible medium of claim 13, wherein the unwanted edges include spurious causation edges.

16. The computer-accessible medium of claim 13, wherein the optimization procedure is a maximum likelihood optimization procedure.

17. The computer-accessible medium of claim 13, wherein the computer arrangement is configured to apply the optimization procedure using at least one regularization score.

18. The computer-accessible of claim 1, wherein the computer arrangement is further configured to apply the at least one financial stress test on at least one financial institution.

19. A method for generating at least one financial stress test comprising:
receiving financial information;
automatically determining at least one causal network based on the financial information;
adjusting at least one false discovery in the at least one causal network;
automatically classifying factor space in the at least one causal network into applicable risky and non-risky constraints;
sampling the at least one causal network based on the risky constraints; and
using a specifically configured computer hardware arrangement, electronically generating at least one financial stress test based on the sampled at least one causal network.

20. A system for generating at least one financial stress test, comprising:
a computer hardware arrangement configured to:
receive financial information;
automatically determine at least one causal network based on the financial information;
adjust at least one false discovery in the at least one causal network;
automatically classify factor in the at least one causal network space into applicable risky and non-risky constraints;
sample the at least one causal network based on the risky constraints; and
electronically generate at least one financial stress test based on the sampled at least one causal network.
